(19) United States
(12) Patent Application Publication
(10) Pub. No.: US 2009/0168614 A1
(43) Pub. Date: Jul. 2, 2009

(54) SPHERICAL ABERRATION CORRECTION APPARATUS AND SPHERICAL ABERRATION CORRECTION METHOD

(75) Inventor: Kenji TAKAGI, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 12/342,028

(22) Filed: Dec. 22, 2008

(30) Foreign Application Priority Data
Dec. 27, 2007 (JP) 2007-338308

(51) Int. Cl. G11B 7/00

(52) U.S. Cl. 369/44.23; G9B/7

(57) ABSTRACT

According to one embodiment, a spherical aberration correction apparatus includes a pickup which applies laser light to an optical disk through an objective lens, a photodetector which detects laser light incident through the objective lens as reflected light from the optical disk, a liquid crystal panel which corrects a spherical aberration of the objective lens with respect to the laser light, a flash-ROM which stores in advance an optimum relationship between a defocus position and a spherical aberration for various optical disk thicknesses, and a control module which measures a thickness of the optical disk by detection of laser light applied to and reflected from the optical disk, and controlling the liquid crystal panel to collect the spherical aberration in accordance with the defocus position of the relationship stored in the flash-ROM for the measured optical disk thickness.

### CROSS-REFERENCE TO RELATED APPLICATIONS

This application is based upon and claims the benefit of priority from Japanese Patent Application No. 2007-338308, filed Dec. 27, 2007, the entire contents of which are incorporated herein by reference.

### BACKGROUND

1. Field

One embodiment of the invention relates to a spherical aberration correction apparatus and a spherical aberration correction method for correcting spherical aberration of a lens for condensing light applied to an optical disk.

2. Description of the Related Art

An optical disk apparatus is configured to condense laser light from a laser light source onto a data recording surface of an optical disk by using an objective lens, in recording and reproduction of extremely small mark information on the data recording surface. However, if there is any variation in the spherical aberration characteristic mainly resulting from a difference in the thickness of the optical disk, recording and reproduction cannot be performed with respect to individual disks under the optimum conditions. Concomitantly with densification of optical disk in recent years, the influence of spherical aberration of an objective lens cannot be neglected now.

Thus, a technique of realizing stable recording and reproducing performance by positively correcting the spherical aberration is generally known (see for example, Jpn. Pat. Appln. KOKAI Publication No. 2007-188632). Further, various techniques utilizing a liquid crystal panel to correct the spherical aberration are proposed.

It should be noted that, because of the influence of the disk thickness, the spherical aberration naturally has a large correlation with the in-focus position, i.e., a defocus position. Accordingly, adjustment for optimizing both the defocus position and the spherical aberration must be carried out. Carrying out the adjustment for each optical disk inserted in the optical disk apparatus will lead to a result that the adjustment time delays a start of recording or reproduction of information on the optical disk. In the conventional case, a two-dimensional search in which spherical aberration and defocus position are made variables has been generally performed. In the two-dimensional search, adjustment of the two variables is repeated until they converge to optimum values. This is a cause of prolonging the adjustment time. Further, it can be considered that the spherical aberration and defocus position are adjusted independently of each other. However, in this case, one of the spherical aberration and the defocus position may not be brought into the optimum state.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view showing the configuration of an optical disk apparatus according to an embodiment of the invention;

FIG. 2 is an exemplary view showing learning processing which is performed in an operation mode for learning a relationship between a thickness of an optical disk shown in FIG. 1 and a spherical aberration of an objective lens;

FIG. 3 is an exemplary view showing spherical aberration adjustment processing shown in FIG. 2 in more detail; and

FIG. 4 is an exemplary view showing the initial adjustment processing which is performed at the time of insertion of the optical disk shown in FIG. 1 in an operation mode for reproducing recorded information.

### DETAILED DESCRIPTION

Various embodiments according to the invention will be described hereinafter with reference to the accompanying drawings.

According to one embodiment of the invention, there is provided a spherical aberration correction apparatus comprising: a light application module which applies laser light to an optical disk through an objective lens; a light detection module which detects laser light incident through the objective lens as reflected light from the optical disk; an aberration correction module which corrects a spherical aberration of the objective lens with respect to the laser light; a memory module which stores in advance an optimum relationship between a defocus position and a spherical aberration for various optical disk thicknesses; and a control module which measures a thickness of the optical disk by detection of laser light applied to and reflected from the optical disk, and controls the aberration correction module to obtain a spherical aberration corresponding to the defocus position of the relationship stored in the memory module for the measured optical disk thickness.

According to one embodiment of the invention, there is provided a spherical aberration correction method which comprises: applying laser light to an optical disk through an objective lens; detecting laser light incident through the objective lens as reflected light from the optical disk; and correcting a spherical aberration of the objective lens with respect to the laser light by an aberration correction module; wherein an optimum relationship between a defocus position and a spherical aberration for various optical disk thicknesses is stored in advance in a memory module, a thickness of the optical disk is measured by detection of laser light applied to and reflected from the optical disk, and the aberration correction module is controlled to obtain a spherical aberration corresponding to the defocus position of the relationship stored in the memory module for the measured optical disk thickness.

In the spherical aberration correction apparatus and the spherical aberration correction method, the optimum relationship between the defocus position and the spherical aberration for various optical disk thicknesses is stored in advance in a memory module. When a thickness of an optical disk is measured by detection of laser light applied to and reflected from the optical disk, the aberration correction module is controlled to obtain a spherical aberration corresponding to the defocus position of the relationship stored in the memory module for the measured optical disk thickness. In this case, it is not necessary to concurrently adjust the spherical aberration and the defocus position in determination of a correction of the spherical aberration, and hence it is possible to shorten the time required to optimize the spherical aberration and the defocus position. Accordingly, a delay in the start of recording or reproduction of information on the optical disk can be reduced. Further, a correction can be calculated from the thickness, and hence the apparatus and the method can also be applied to a virgin disk.

An optical disk apparatus according to an embodiment of the invention will be described below.

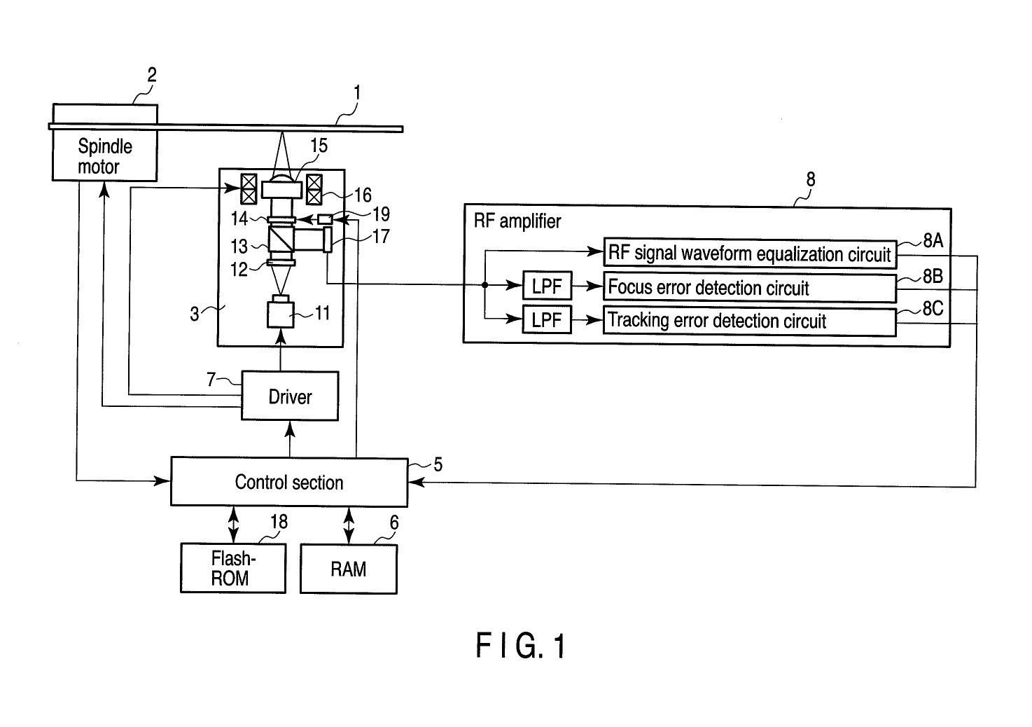

FIG. 1 shows the configuration of the optical disk apparatus. In order to reproduce recorded information from an optical disk 1, the optical disk apparatus includes a spindle motor 2, a pickup 3, a control module 5, a RAM 6, a driver 7, an RF amplifier 8, a flash-ROM 18, and a driver 19. Upon insertion into the optical disk apparatus, the optical disk 1 is rotatably attached to the spindle motor 2. The spindle motor 2 includes a frequency generator which generates a rotation angle signal corresponding to the rotation angle of the spindle motor 2. The rotation angle signal is supplied to the control module 5. The control module 5 compares the rotation angle signal with an internal reference frequency and controls the driver 7 to set the spindle motor 2 to a rotational number and direction predetermined according to a result of comparison. In addition, it is possible to perform a control of maintaining the linear speed constant if the rotation angle signal is generated from a wobble signal formed in advance on the disk. The pickup 3 is provided to face a data recording surface of the optical disk 1, applies laser light to the data recording surface of the optical disk 1, and receives reflected light from the data recording surface. The pickup 3 is movable in a radial direction of the optical disk 1 by a carrying mechanism such as a lead screw or the like rotated by a thread motor (not shown). The reflected light received by the pickup 3 is subjected to photoelectric conversion, is thereafter amplified and subjected to signal processing by the RF amplifier 8, and is then supplied to the control module 5. The control module 5 performs a control required for reproduction of recorded information from the optical disk 1. The flash-ROM 18 stores a control program of the control module 5 and initial data. The RAM 6 stores various data items to be processed by the control module 5.

The pickup 3 includes a laser light source 11, a collimating lens 12, a beam splitter 13, a liquid crystal panel 14, an objective lens 15, an actuator 16, a photodetector 17, and the driver 19 for use in a liquid crystal panel control. The laser light source 11 and the actuator 16 are driven by the driver 7, and the liquid crystal panel 14 is driven by the driver 19. The laser light source 11 includes a plurality of semiconductor lasers (laser diodes) provided for the types of the optical disk 1 such as a DVD and HD_DVD. Laser light from the laser light source 11 is converted into parallel light by the collimating lens 12, then is passed through the beam splitter 13 and the liquid crystal panel 14, and is made incident on the objective lens 15. The objective lens 15 condenses the incident light, and applies the light to the data recording surface of the optical disk 1. The reflected light from the data recording surface is made incident on the beam splitter 13 through the objective lens 15 and the liquid crystal panel 14, and is then guided to the photodetector 17 by the beam splitter 13. The photodetector 17 subjects the reflected light from the data recording surface to photoelectric conversion, and supplies the resultant to the RF amplifier 8 as a radio-frequency (RF) signal. The RF amplifier 8 includes an RF signal waveform equalization circuit 8A which equalizes a waveform of the RF signal for phase compensation, a focus error detection circuit 8B for detecting a focus error from the RF signal through a low-pass filter (LPF), and a tracking error detection circuit 8C for detecting a tracking error from the RF signal through a low-pass filter (LPF). Output signals from these circuits 8A to 8C are processed by the control module 5, and are used to control the driver 7 and the driver 19. The actuator 16 is driven by the driver 7 to change the position of the objective lens 15 in the optical axis direction (focusing direction) of the laser light for focus adjustment and to change the position of the objective lens 15 in the radial direction (tracking direction) of the optical disk 1 for tracking adjustment.

The liquid crystal panel 14 is an aberration correction module which corrects a spherical aberration of the objective lens 15. In the liquid crystal panel 14, a plurality of control electrodes are formed to be concentric with respect to the center of the objective lens 15, and the applied voltages of these control electrodes are set at a gradient corresponding to a correction of the spherical aberration. The liquid crystal panel 14 is driven by the driver 19.

Further, the flash-ROM 18 is also used as a memory module which stores an optimum relationship between a defocus position and a spherical aberration for various thicknesses of the optical disk 1 as a relational expression. Prior to reproduction of the recorded information from the optical disk 1, the control module 5 measures the thickness of the optical disk 1 by detection of laser light applied to the pickup 3 and reflected from the optical disk 1, and controls the liquid crystal panel 14 through the driver 19 to obtain a spherical aberration corresponding to the defocus position of the relationship stored in the flash-ROM 18 for the measured thickness of the optical disk 1.

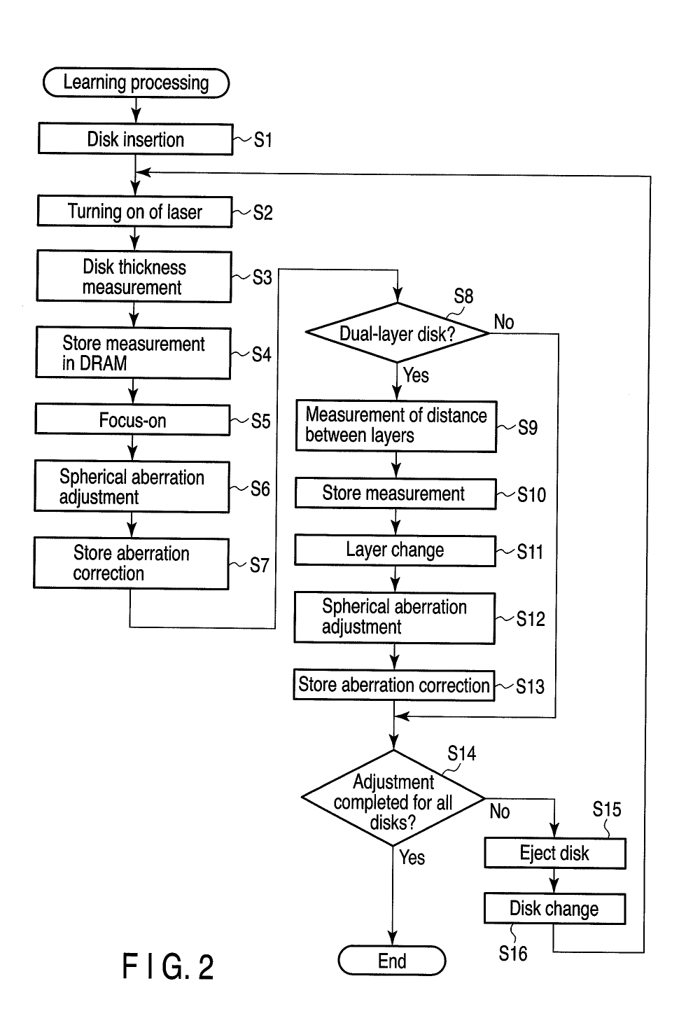

FIG. 2 shows learning processing which is performed in an operation mode for learning the relationship between the thickness of the optical disk 1 and the spherical aberration of the objective lens 15. This learning processing is normally performed prior to the shipment of the optical disk apparatus.

When the learning processing is started in the control module 5, insertion of the optical disk 1 is confirmed in block S1, the laser light source 11 is turned on in block S2, and the thickness of the optical disk 1 is measured in block S3. The thickness of the optical disk 1 is measured by, for example, detecting a time difference between the time required to detect the reflected light from the front surface of the optical disk 1, and the time required to detect the reflected light from the data recording surface of the optical disk 1, and by converting the time difference into a difference between the distances from the pickup 3 to the front surface of the optical disk 1 and the data recording surface. In block S4, the thickness obtained as a result of the measurement is stored in the flash-ROM 18. In subsequent block S5, the objective lens 15 is brought into a focus-on state, then in block S6, adjustment of the spherical aberration is performed by using the liquid crystal panel 14 as spherical aberration adjustment processing, and the optimum aberration correction in the focus-on state is stored in the flash-ROM 18. In block S8, it is checked whether or not the optical disk 1 is a dual-layer disk further having another data recording surface. When it is confirmed here that the optical disk is a dual-layer disk, a distance between these layers is measured by the time difference detection scheme described above in block S9, and a measurement is stored in the flash-ROM 18 in block S10. Thereafter, layer change for changing the measurement object to another data recording surface is performed in block S11, adjustment of the spherical aberration is performed for the data recording surface of the change destination as spherical aberration adjustment processing in block S12, and the optimum aberration correction obtained as a result of the processing is stored in the flash-ROM 18 in block S13.

When it is confirmed that the optical disk 1 is not a dual-layer disk in block S8, or when the execution of block S13 is completed, it is checked whether or not the adjustment has been completed for various optical disks 1 of different thicknesses in block S14. If there is any other optical disk 1 for which the adjustment has not been completed yet, the optical disk 1 is ejected in block S15. When it is confirmed that disk change to the other optical disk 1 has been performed in block S16 subsequently to this, block 2 is executed again. On the other hand, when it is confirmed in block S14 that the adjustment has been completed for all the optical disks 1, the learning processing is terminated.

Incidentally, when the layer resolution of the pickup 3 is poor, the accuracy of the thickness measurement by the time difference detection scheme is lowered, and thus measurement of the thickness is performed by observing the drive voltage of the actuator 16 in a state where the focusing servo is actually applied. Here, in order to eliminate noise cased by a side-runout component, it is sufficient if the runout at the same point of the circumference is observed by using a signal synchronized with the rotation of the optical disk 1. Further, the influence of the side-runout may be eliminated by lowering the cutoff frequency of the low-pass filter (LPF) provided to the RF amplifier 8, and by using an average of the runout of one rotation. In the case of a dual-layer disk, the stored data may be an absolute value, or may be a difference from the O-layer. Further, this is not limited to the dual-layer disk, and the same method can be applied to a multilayer disk.

In the above-mentioned learning processing, the relationship between the distance and the correction of the spherical aberration by the liquid crystal panel 14 is repeatedly acquired with respect to various optical disks 1 different from each other in thickness and interlayer distance. An optical disk which is made the processing object of the learning processing is arbitrary, and by making several types of optical disks 1 the processing object, a highly accurate expression can be derived. However, the number of processing objects and the learning time have a trade-off relationship with each other.

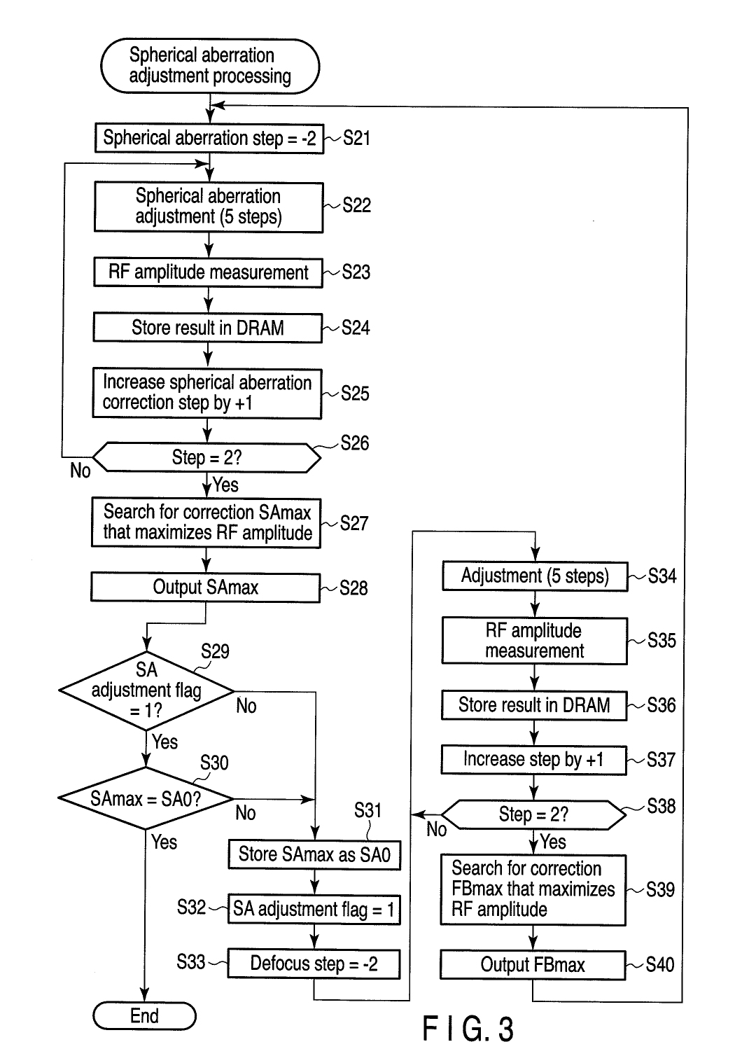

FIG. 3 shows spherical aberration adjustment processing which is performed in blocks S6 and S12 shown in FIG. 2 in more detail. In this spherical aberration adjustment processing, although the adjustment index is the amplitude (RF amplitude) of the RF signal obtained from the photodetector 17, the tracking error amplitude, byte error rate, address (ATIP/ADIP/LPP/WAP etc.) read rate and the like may also be used. Further, each index may be combined with each other in a manner that the index is between the correction that enables the RF amplitude to obtain the best result and the correction that enables the tracking error to obtain the best result. In the case of FIG. 3, first, the correction of the spherical aberration is changed in five steps of (−2, −1, 0, 1, 2) so as to calculate a value that provides the best result, and subsequently the defocus is changed in five steps of (−2, −1, 0, 1, 2) so as to calculate a defocus position that provides the best result. Such a series of operations is repeated, and when the correction of the spherical aberration converges, the adjustment is terminated. At this time, the number of steps, and the step width are arbitrary. Further, the correction in each step may not necessarily be one of consecutive values, and the best point may not necessarily be in the five steps. Further, the number of steps and the step width may be changed in accordance with the number of loops. Further, as is introduced in “optical information processing apparatus and optical information processing method (Jpn. Pat. Appln. KOKAI Publication No. 2007-188632)”, all the indices such as RF amplitudes or the like at points on a plane having the spherical aberration and the defocus as the (X, Y) coordinates may be measured in a certain range, and the best correction may be calculated and selected from them.

When the spherical aberration adjustment processing is actually started, the spherical aberration correction step is set at −2 in step S21, the spherical aberration adjustment using this correction is performed in block S22, and an RF amplitude obtained as a result of the adjustment is measured in block S23. This measurement is stored in the flash-ROM 18 in block S24. Subsequently to this, the spherical aberration correction step is increased by +1 in block S25, and it is checked in block S26 whether or not the step has become 2 (step=2). If the step is not 2, blocks S22 to S26 are repeated. When the step becomes 2 in block S26, the correction SAmax that maximizes the RF amplitude is searched for in block S27, and SAmax is output in block S28. Subsequently, it is checked in block S29 whether or not the SA adjustment flag is 1. When the SA adjustment flag is 1, it is further checked in block S30 whether or not SAmax is equal to SA0 (SAmax=SA0). When it is confirmed that SAmax is equal to SA0 (SAmax=SA0), the adjustment processing is terminated. On the other hand, when it is confirmed in block S29 that the SA adjustment flag is not 1, or when it is confirmed that SAmax is not equal to SA0, SAmax is stored as SA0 in block S31, and the SA adjustment flag is set at 1 in block S32. Thereafter, in block S33, defocus step is set at −2, the adjustment is performed in block S34, and the RF amplitude obtained at this point is measured in block S35. This measurement is stored in the flash-ROM 18 in block S36. Subsequently to this, defocus step is increased by +1 in block S37, and it is checked in block S38 whether or not defocus step has become 2. When defocus step is not 2, blocks S34 to S38 are repeated. When defocus step becomes 2 in block S38, the correction FBmax that maximizes the RF amplitude is searched for in block S39, and FBmax is output in block S40. After this, block S21 is executed again.

In the manner described above, the optimum relationship between the defocus position and the spherical aberration is obtained for various optical disk thicknesses, and the relationship is stored in the flash-ROM 18 as a relational expression.

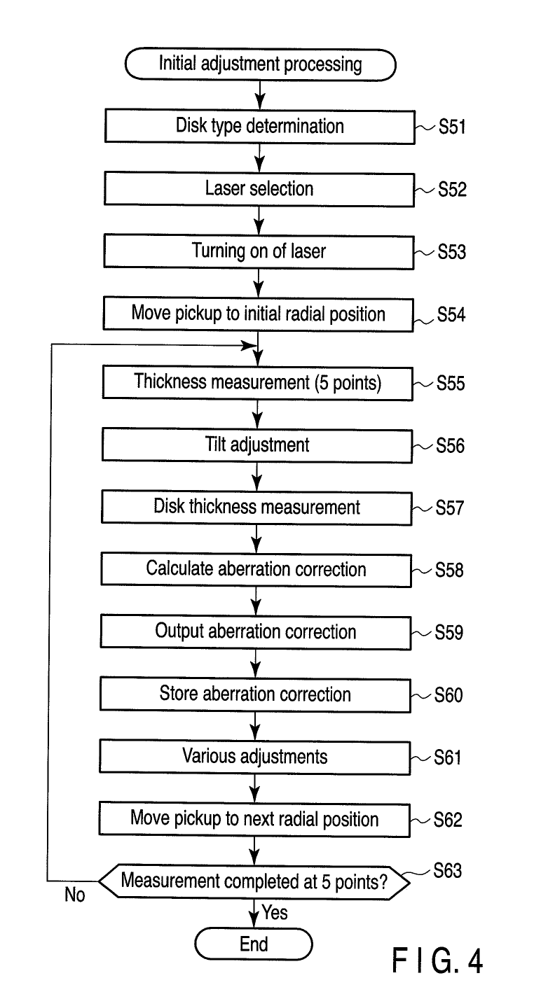

FIG. 4 shows initial adjustment processing which is performed at the time of insertion of the optical disk 1 in an operation mode for reproducing the recorded information. When this initial adjustment processing is started in the control module 5, the type of the optical disk 1 is determined in block S51, a semiconductor laser provided in the laser light source 11 for the type of the optical disk 1 is selected in block S52, the laser light source 11 is turned on in block S53, and the pickup 3 is moved to the initial radial position in block S54. In block S55 subsequent to this, the optical disk 1 is divided into a plurality of regions in the radial direction, and measurement of the thickness is performed at a point in each of these regions. Here, five measurement points are set. When the thickness of the optical disk 1 is measured at one measurement point in block S55, tilt adjustment is performed in block S56 in accordance with a tilt of the optical disk 1 which can be detected from the measurement, and the thickness measurement is performed again in block S57. After this, a correction corresponding to the thickness of the measurement is calculated from the relational expression preserved in advance in the flash-ROM 18 in the learning processing, the calculated correction is output to the liquid crystal panel 14 with respect to the region of the optical disk 1 including the measuring point in block S59, and the correction is further stored in the RAM 6 for various correction purposes in block S60. In block S61, various adjustments are performed on the basis of this correction. After this, the pickup 3 is moved to a radial position opposed to a measurement point of the next region in block S62, and then it is checked in block S63 whether or not thickness measurement has been completed at five points. If the measurement is not completed at five points, then blocks S55 to S63 are repeated. When it is confirmed that thickness measurement has been completed at all the five points, the initial adjustment processing is terminated.

In the above-mentioned initial adjustment processing, the optimum correction of the spherical aberration is univocally calculated from the relational expression, and hence the value need not be recorded on the optical disk 1, and even a virgin disk can be corrected. Further, although five measurement points are set, the place of the measurement point, and the region dividing method are arbitrary. Further, if there is a tilt in the optical disk 1, an error is caused in the measurement of the thickness. Particularly, when the measurement is performed at the outer circumferential part of the optical disk 1, it is desirable that the influence of the tilt be eliminated by the tilt adjustment. On the other hand, when the measurement is performed at the inner circumferential part of an optical disk 1 in which an influence of the tilt is comparatively small, the tilt adjustment may be omitted to shorten the time needed for the tilt adjustment.

In this embodiment, the optimum relationship between the spherical aberration and the defocus position is stored in advance in a memory module such as the flash-ROM 18 for various thicknesses of the optical disk 1. When the thickness of the optical disk 1 is measured by detection of laser light applied to the optical disk 1 and reflected from the optical disk 1, the liquid crystal panel 14 is controlled to obtain a spherical aberration corresponding to the defocus position of the relationship stored in the flash-ROM 18 for the measured thickness of the optical disk 1. In this case, it is not necessary to concurrently adjust the spherical aberration and the defocus position in determination of a correction of the spherical aberration, and hence it is possible to shorten the time needed for the optimization of the spherical aberration and the defocus position. Accordingly, it is possible to reduce a delay in the start of recording information on the optical disk 1 or reproduction of the recorded information.

Incidentally, the invention is not limited to the above-mentioned embodiment, and can be variously modified within a scope not deviating from the gist of the invention.

In this embodiment, the flash-ROM 18 stores the optimum relational expression of the relationship between the defocus position and the spherical aberration for various thicknesses of the optical disk 1 obtained as a result of the learning processing. However, the flash-ROM 18 may store the optimum relationship between the defocus position and the spherical aberration for the various thicknesses of the optical disk 1 as a data table in place of the relational expression. Further, the flash-ROM 18 may be replaced with a nonvolatile memory other than the flash-ROM 18. Further, the learning processing may be performed not only before the shipment of the optical disk apparatus, but also may be performed after the shipment of the optical disk apparatus by the user. In this case, a result of the learning processing performed after the shipment may be preserved in, for example, the RAM 6 which is a DRAM, without being limited to a nonvolatile memory such as the flash-ROM 18. Moreover, the result of the learning processing may be preserved after the shipment of the optical disk apparatus in, for example, a nonvolatile memory such as the flash-ROM 18 as, for example, renewal of the firmware.

Further, the liquid crystal panel 14 may be replaced with a concave lens and an aberration correction module which corrects the spherical aberration of the objective lens 15 by changing the position of the concave lens in the optical axis direction of the laser light. In this case, the driver 19 may not be included in the pickup 3 to drive the aberration correction module.

Furthermore, in the above-mentioned embodiment, the optical disk apparatus is configured to reproduce recorded information from the optical disk 1. This optical disk apparatus may further be configured to record information on the optical disk 1.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A spherical aberration correction apparatus comprising:
a laser configured to irradiate laser light on an optical disk through an objective lens;
a light detector configured to detect laser light reflected from the optical disk;
an aberration correction module configured to correct a spherical aberration of the objective lens with respect to the laser light;
a memory configured to store a relationship between a defocus position and a spherical aberration corresponding to a plurality of optical disk thicknesses; and
a controller configured to measure a thickness of the optical disk by detection of laser light irradiated on and reflected from the optical disk, and to control the aberration correction module in order to obtain a spherical aberration corresponding to the defocus position of the relationship stored in the memory for the measured optical disk thickness.

2. The spherical aberration correction apparatus of claim 1, wherein the memory is configured to store the relationship between the defocus position and the spherical aberration for the plurality of optical disk thicknesses as a relational expression.

3. The spherical aberration correction apparatus of claim 1, wherein the memory is a nonvolatile memory configured to store the relationship between the defocus position and the spherical aberration for the plurality of optical disk thicknesses.

4. The spherical aberration correction apparatus of claim 1, wherein the aberration correction module comprises a liquid crystal panel.

5. The spherical aberration correction apparatus of claim 1, wherein the aberration correction module comprises a concave lens, and is configured to change a position of the concave lens in an optical axis direction of the laser light.

6. A spherical aberration correction method comprising:
irradiating laser light on an optical disk through an objective lens;
detecting laser light reflected from the optical disk; and
correcting a spherical aberration of the objective lens with respect to the laser light;
storing a relationship between a defocus position and a spherical aberration corresponding to a plurality of optical disk thicknesses in a memory;
measuring a thickness of the optical disk by detection of laser light irradiated on and reflected from the optical disk; and
controlling the correction of the spherical aberration in order to obtain a spherical aberration corresponding to the defocus position of the relationship stored in the memory for the measured optical disk thickness.

7. The spherical aberration correction method of claim 6, wherein the relationship between the defocus position and the spherical aberration for the plurality of optical disk thicknesses is acquired by a machine-learning process, and the relationship is stored in the memory as a relational expression.

8. The spherical aberration correction method of claim 6, wherein the memory is a nonvolatile memory, the relationship between the defocus position and the spherical aberration for the plurality of optical disk thicknesses is acquired beforehand by a machine-learning process, and the relationship is stored in the nonvolatile memory.

9. The spherical aberration correction method of claim 6, wherein the aberration correction module comprises a liquid crystal panel.

10. The spherical aberration correction method of claim 6, wherein the aberration correction module comprises a concave lens, and is configured to change a position of the concave lens in an optical axis direction of the laser light.
